(19) United States
(12) Patent Application Publication
(10) Pub. No.: US 2008/0200130 A1
(43) Pub. Date: Aug. 21, 2008

(54) System and method for wireless transmission

(76) Inventor: Yu-Tsung Chang, Chu-Nan Chen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/707,030

(22) Filed: Feb. 16, 2007

(51) Int. Cl. H04B 1/38

(52) U.S. Cl. 455/73

(57) ABSTRACT

A system and a method for wireless transmission are disclosed. The system includes an electronic apparatus, a box and a transformer. The electronic apparatus has a transceiver for receiving a first signal based on a predetermined wireless communication protocol. The box includes a plurality of receiving units, and the receiving units are provided for respectively receiving wireless communication signals through respective wireless communication protocols. The transformer is disposed in the box for transforming the wireless communication signals to generate a second signal that is compatible with the predetermined wireless communication protocol.

### FIELD OF THE INVENTION

The present invention generally relates to a system and a method for wireless transmission, and more specifically relates to integrate a plurality of antennas for various frequency bands in a single box and then utilize a single band to transmit data to an electronic apparatus in order to execute corresponding application programs.

### BACKGROUND OF THE INVENTION

As wireless communication technology is in widespread use, more and more electronic apparatuses are equipped with wireless communication elements to achieve wireless communication capability.

To achieve the aforesaid functionality, antennas which are the wireless communication elements are applied to a personal computer for receiving various signals from different remote devices. The antennas may correspond to various frequency bands such as WiMAX (Worldwide Interoperability for Microwave Access), WiFi (wireless fidelity), BT (Bluetooth), DTV (digital television), UWB (ultra wide band), GPS (Global Positioning System) and 3G (the third generation). However, the personal computer may not equip with many antennas due to the cost consideration. In another word, the personal computer in the art may only equip with fewer antennas to receive few frequency bands without any flexibility. Consequently, if a user would like to utilize more frequency bands from his/her personal computer, the personal computer will be entirely replaced to cause great inconvenience.

To overcome the foregoing shortcomings, the inventor(s) of the present invention based on years of experience in the related field to conduct extensive researches and experiments, and finally invented a system and a method for wireless transmission, as a method or a basis for resolving the foregoing drawbacks.

### SUMMARY OF THE INVENTION

Briefly, it is a primary object of the present invention to provide a system and a method for wireless transmission to integrate a plurality of antennas for various frequency bands in a single box and then utilize a single band to transmit data to an electronic apparatus in order to execute corresponding application programs.

To achieve the foregoing object of the present invention, the wireless transmission system includes an electronic apparatus, a box and a transformer. The electronic apparatus has a transceiver for receiving a first signal based on a predetermined wireless communication protocol. The box has a plurality of receiving units, such as antennas, for respectively receiving wireless communication signals through respective wireless communication protocols. The transformer is disposed in the box for transforming the wireless communication signals transmitted from the receiving units to generate a second signal that is compatible with the predetermined wireless communication protocol.

The electronic apparatus includes a computer, a personal digital assistant (PDA), a mobile phone, a camera or other electronic apparatuses with wireless communication capability. The receiving units are preferably wireless antennas corresponding to various frequency bands employed by WiMAX, WiFi, BT, DTV, UWB, GPS and 3G. The wireless communication protocol is preferably adapted to WiFi for a wireless local area network. The wireless communication signals can be transmitted from various remote devices. The first and second signals are preferably applied to WiMAX, WiFi, BT, DTV, UWB, GPS or 3G that complies with the international communication standards. The electronic apparatus further includes a multiplexer for analyzing the first signal back into one of the wireless communication signals, and the multiplexer uses a multiplexing algorithm to process the first signal. Alternatively, the first signal transmitted from the transceiver of the electronic apparatus can be processed by a processor disposed in the electronic apparatus to determine whether or not the first signal matches one of the wireless communication signals through a head of the first signal. Furthermore, since the first signal matches one of the wireless communication signals, a corresponding application program installed in the electronic apparatus can be executed to perform necessary functions corresponding to one of the wireless communication signals.

A second object of the present invention is to provide a wireless transmission method, and the method includes the following steps of:

(a). Receiving a first signal by a transceiver disposed in an electronic apparatus based on a predetermined wireless communication protocol;

(b). Respectively receiving wireless communication signals by a plurality of receiving units disposed in a box through respective wireless communication protocols; and

(c). Transforming the wireless communication signals by a transformer disposed in the box to generate a second signal that is compatible with the predetermined wireless communication protocol.

By integrating the plurality of antennas in the box and utilizing a single band to transmit data to the electronic apparatus, the apparatus does not need to be replaced when the prior art only allows the electronic apparatus to equip with few antennas.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a block diagram of a wireless transmission system of the invention;

FIG. 2 is a detail block diagram of a wireless transmission system of the invention;

FIG. 3 is a flow chart illustrating a wireless transmission method of the invention; and

FIG. 4 is a detail flow chart illustrating 3G taken as an example for a wireless transmission method of the invention.

### DETAILED DESCRIPTION OF THE PREFERRED EMBODIMENTS

Referring to the related figures for the system and the method for wireless transmission according to a preferred embodiment of the present invention, wherein the same elements are described by the same reference numerals.

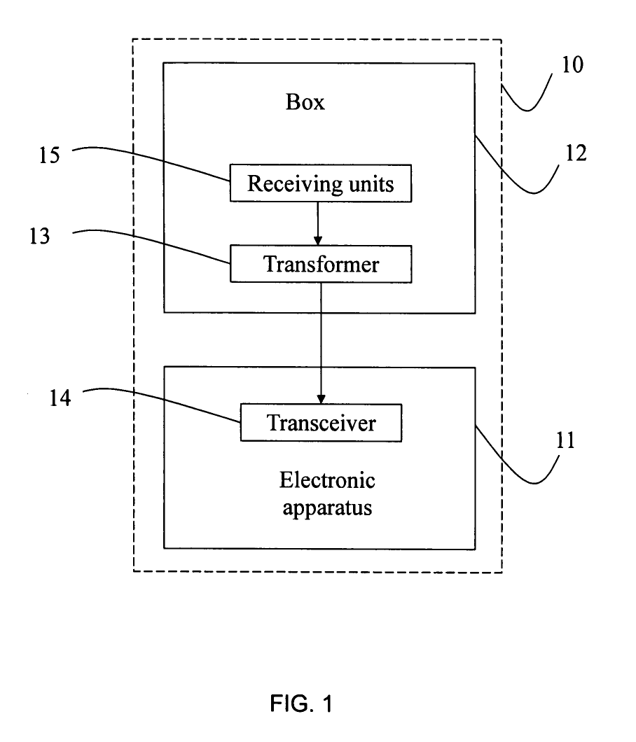

Referring to FIG. 1 for the block diagram of a wireless transmission system of the invention is illustrated. The wireless transmission system 10 comprises an electronic apparatus 11, a box 12 and a transformer 13. The electronic apparatus 11 has a transceiver 14 for receiving a first signal based on a predetermined wireless communication protocol. The box 12 has a plurality of receiving units 15 for respectively receiving wireless communication signals through respective wireless communication protocols. The transformer 13 is disposed in the box 12 for transforming the wireless communication signals to generate a second signal that is compatible with the predetermined wireless communication protocol.

The electronic apparatus 11 includes a computer, a personal digital assistant (PDA), a mobile phone, a camera or other electronic apparatuses with wireless communication capability. The receiving units 15 are preferably wireless antennas corresponding to various frequency bands employed by WiMAX (Worldwide Interoperability for Microwave Access), WiFi (wireless fidelity), BT (Bluetooth), DTV (digital television), UWB (ultra wide band), GPS (Global Positioning System) and 3G (the third generation). Herein the wireless communication protocol is preferably adapted to WiFi or the other wireless protocols which can be set by an operator. The wireless communication signals can be transmitted from various remote devices. The first and second signals are preferably applied to WiMAX, WiFi, BT, DTV, UWB, GPS or 3G that complies with the international communication standards. The electronic apparatus can further include a multiplexer (not shown in the embodiment) for analyzing the first signal back into one of the wireless communication signals, and the multiplexer uses a multiplexing algorithm to process the first signal. Alternatively, the first signal transmitted from the transceiver 14 can be processed by a processor (not shown in the figure) disposed in the electronic apparatus to determine whether or not the first signal matches one of the wireless communication signals through a head of the first signal. Furthermore, since the first signal matches one of the wireless communication signals, a corresponding application program installed in the electronic apparatus can be executed to perform necessary functions corresponding to one of the wireless communication signals.

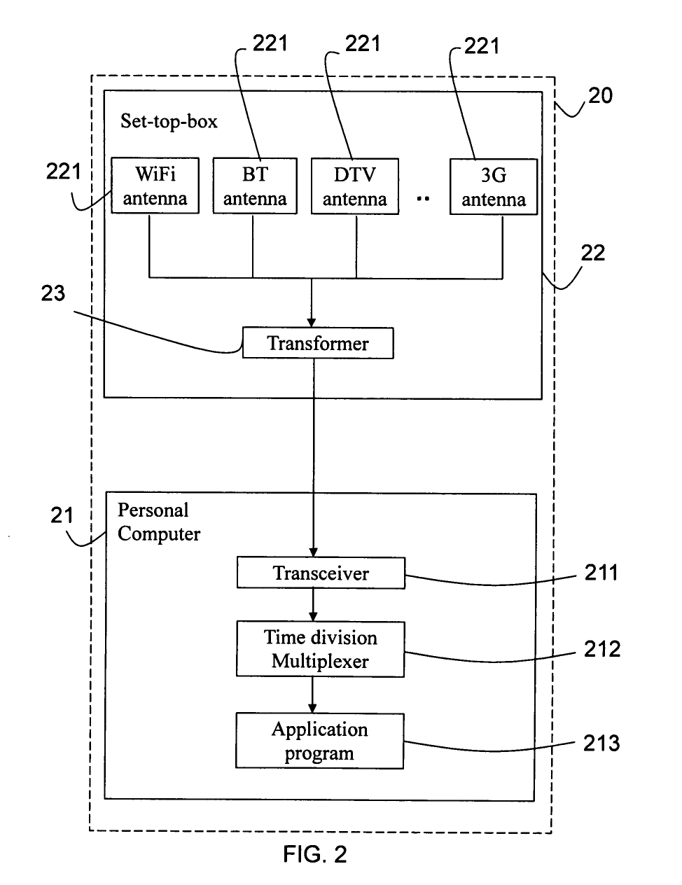

Referring to FIG. 2 for the detail block diagram of a wireless transmission system of the invention is illustrated. The wireless transmission system 20 includes a personal computer 21, a set-top-box 22 and a transformer 23. The personal computer 21 includes a transceiver 211 for receiving a first signal (WiFi) based on a predetermined wireless communication protocol (an IEEE 802.11). The set-top-box 22 is equipped with a plurality of antennas 221 corresponding to various frequency bands employed by WiMAX, WiFi, BT, DTV, UWB, GPS and 3G. It should be noted that the plurality of antennas 221 can include more wireless communication specifications and it is not only limited to WiMAX, WiFi, BT, DTV, UWB, GPS and 3G. These antennas 221 are provided for respectively receiving wireless signals transmitted by remote devices (e.g. a wireless camera, global positioning system receiver for BT, DTV stations and 3G base-stations) through respective wireless communication protocols. The transformer 23 disposed in the set-top-box 22 then transforms the wireless signals to generate a second signal that is compatible with the predetermined wireless communication protocol (WiFi). The personal computer 21 further has a time division multiplexer 212 for analyzing the first signal back into one of the wireless signals. Alternatively, the first signal transmitted from the transceiver 211 can be processed by a microprocessor (not shown in the figure) disposed in the personal computer 21 to determine whether or not the first signal matches one of the wireless signals through a head of the first signal. Since the first signal matches one of the wireless signals, a corresponding application program 213 (e.g. a DTV player application or a Skype application for BT) installed in the personal computer 21 is executed to perform necessary functions corresponding to one of the wireless signals.

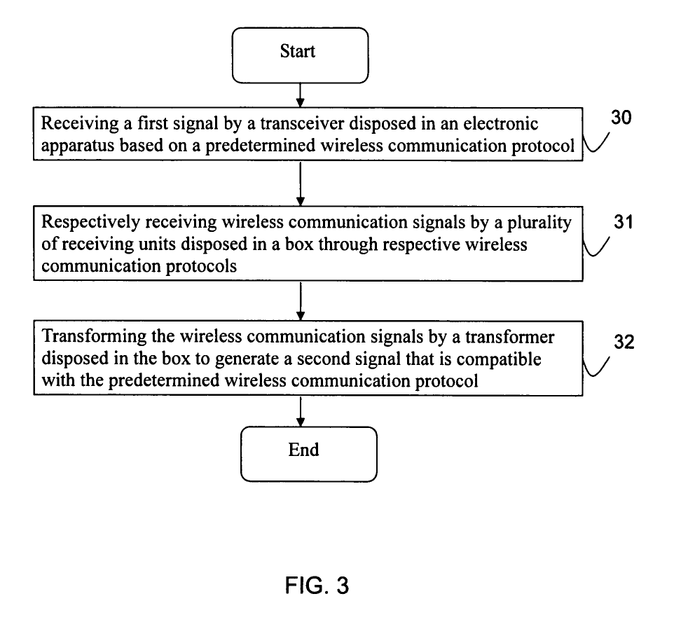

Referring to FIG. 3 for the flow chart of a wireless transmission method of the invention is illustrated. The method includes the following steps:

Step 30: receiving a first signal by a transceiver disposed in an electronic apparatus based on a predetermined wireless communication protocol;

Step 31: respectively receiving wireless communication signals by a plurality of receiving units disposed in a box through respective wireless communication protocols; and

Step 32: transforming the wireless communication signals by a transformer disposed in the box to generate a second signal that is compatible with the predetermined wireless communication protocol.

Moreover, a multiplexer disposed in an electronic apparatus is provided for analyzing the first signal back into one of the wireless communication signals. Alternatively, the first signal transmitted from the transceiver can be processed by a processor disposed in the electronic apparatus to determine whether or not the first signal matches one of the wireless communication signals through a head of the first signal. Since the first signal matches one of the wireless communication signals, a corresponding application program installed in the electronic apparatus is executed.

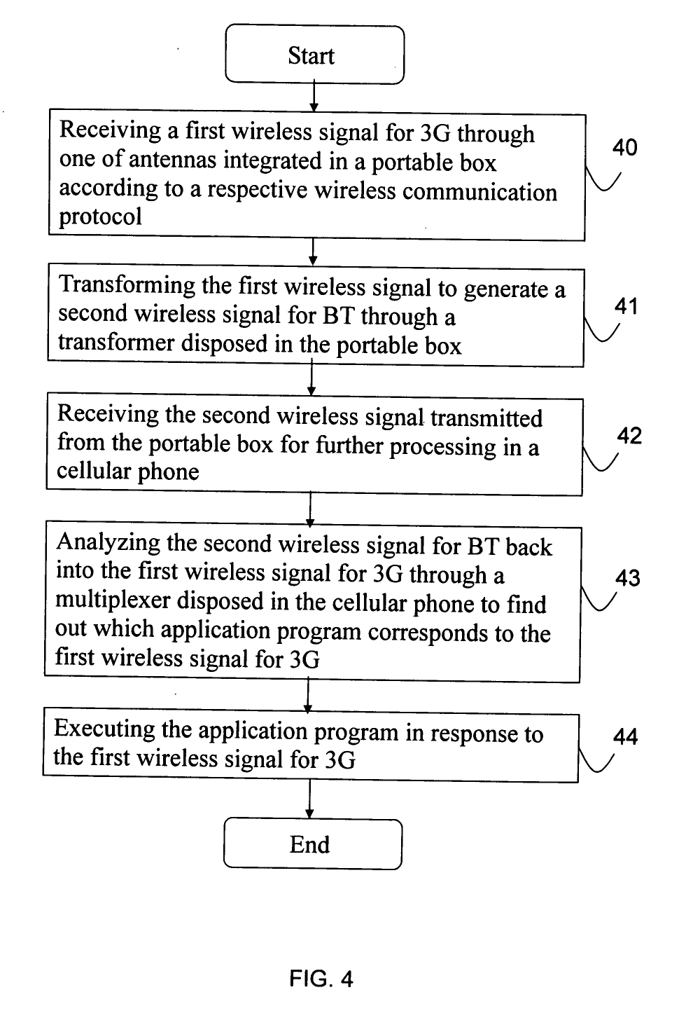

Referring to FIG. 4 for a flow chart illustrates a wireless transmission method of the invention. The method takes 3G as an example and includes the following steps of:

Step 40: receiving a first wireless signal for 3G through one of antennas integrated in a portable box according to a respective wireless communication protocol;

Step 41: transforming the first wireless signal to generate a second wireless signal for BT through a transformer disposed in the portable box;

Step 42: receiving the second wireless signal transmitted from the portable box for further processing in a cellular phone;

Step 43: analyzing the second wireless signal for BT back into the first wireless signal for 3G through a multiplexer disposed in the cellular phone to find out which application program corresponds to the first wireless signal for 3G; and

Step 44: executing the application program in response to the first wireless signal for 3G.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless transmission system comprising:
an electronic apparatus having a transceiver for receiving a first signal based on a predetermined wireless communication protocol;
a box having a plurality of receiving units, and the receiving units for respectively receiving wireless communication signals through respective wireless communication protocols; and
a transformer disposed in the box for transforming the wireless communication signals to generate a second signal that is compatible with the predetermined wireless communication protocol.

2. The wireless transmission system of claim 1, wherein the electronic apparatus includes a computer, a personal digital assistant (PDA), a mobile phone, a camera or other electronic apparatuses with wireless communication capability.

3. The wireless transmission system of claim 1, wherein the receiving units are wireless antennas corresponding to various frequency bands employed by WiMAX (Worldwide Interoperability for Microwave Access), WiFi (wireless fidelity), BT (Bluetooth), DTV (digital television), UWB (ultra wide band), GPS (Global Positioning System) and 3G (the third generation).

4. The wireless transmission system of claim 1, wherein the wireless communication protocol is adapted to WiFi for a wireless local area network (WLAN).

5. The wireless transmission system of claim 1, wherein the wireless communication signals are transmitted from various remote devices.

6. The wireless transmission system of claim 1, wherein the first and second signals are applied to WiMAX, WiFi, BT, DTV, UWB, GPS or 3G.

7. The wireless transmission system of claim 1, wherein the electronic apparatus further includes a multiplexer for analyzing the first signal back into one of the wireless communication signals.

8. The wireless transmission system of claim 7, wherein the multiplexer uses a multiplexing algorithm to process the first signal.

9. The wireless transmission system of claim 1, wherein the first signal transmitted from the transceiver is processed by a processor disposed in the electronic apparatus to determine whether or not the first signal matches one of the wireless communication signals through a head of the first signal.

10. The wireless transmission system of claim 1, wherein since the first signal matches one of the wireless communication signals, a corresponding application program installed in the electronic apparatus is executed.

11. A wireless transmission method comprising the steps of:
receiving a first signal by a transceiver disposed in an electronic apparatus based on a predetermined wireless communication protocol;
respectively receiving wireless communication signals by a plurality of receiving units disposed in a box through respective wireless communication protocols; and
transforming the wireless communication signals by a transformer disposed in the box to generate a second signal that is compatible with the predetermined wireless communication protocol.

12. The wireless transmission method of claim 11, wherein the electronic apparatus includes a computer, a personal digital assistant (PDA), a mobile phone, a camera or other electronic apparatuses with wireless communication capability.

13. The wireless transmission method of claim 11, wherein the receiving units are wireless antennas corresponding to various frequency bands employed by WiMAX (Worldwide Interoperability for Microwave Access), WiFi, BT, DTV, UWB (ultra wide band), GPS (Global Positioning System) and 3G.

14. The wireless transmission method of claim 11, wherein the wireless communication protocol is adapted to WiFi for a wireless local area network.

15. The wireless transmission method of claim 11, wherein the wireless communication signals are transmitted from various remote devices.

16. The wireless transmission method of claim 11, wherein the second signal is applied to WiMAX, WiFi, DTV, BT, UWB, GPS or 3G.

17. The wireless transmission method of claim 11, wherein the electronic apparatus further includes a multiplexer for analyzing the first signal back into one of the wireless communication signals.

18. The wireless transmission method of claim 17, wherein the multiplexer uses a multiplexing algorithm to process the first signal.

19. The wireless transmission method of claim 11, wherein the first signal transmitted from the transceiver is processed by a processor disposed in the electronic apparatus to determine whether or not the first signal matches one of the wireless communication signals through a head of the first signal.

20. The wireless transmission method of claim 11, wherein since the first signal matches one of the wireless communication signals, a corresponding application program installed in the electronic apparatus is executed.
